(19) United States
(12) Patent Application Publication
(10) Pub. No.: US 2004/0031653 A1
(43) Pub. Date: Feb. 19, 2004

(54) Half auto air bleeding cylinder

(76) Inventor: Kyoung Hae Kim, Los Angeles, CA (US)

Correspondence Address: KYOUNG HAE KIM, 146 DOUGLAS ST. #10, LOS ANGELES, CA, 90026, US

(21) Appl. No.: 10/217,589

(22) Filed: Aug. 13, 2002

(51) Int. Cl. B60T 11/00

(52) U.S. Cl. 188/352

(57) ABSTRACT

This invention can do air bleeding work more easy way, so save labor and time. Also can solve vapor lock problem easy way.

And the air bleeding nipple is stuck up or the working room for moving hand for the air bleeding work is very small or can not reach, so if the air bleeding work can not do perfectly. We can use Half Auto Air Bleeding Cylinder.

### BACKGROUND OF THE INVENTION

I. Field of the Invention

This invention makes air bleeding work more easy way, so save efforts and a lot of time. In case of jumbo air plane, can save two hours and six person's effort and working. This invention should be combinationed with wheel cylinder, except heavy machine, the wheel of heavy machine is also the same but if a heavy machine need a air bleeding, this half auto air bleeding cylinder can solve the problem and the heavy machine can work exactly and no shaking.

II. Description of the Prior Art

The air bleeding nipple is stuck up or the working room for moving hand for the air bleeding work is very small or can not reach, so if the air bleeding work can not do perfectly, we can use Half Auto Air Bleeding Cylinder.

### SUMMARY OF THE INVENTION

If in a case vapor lock occur in the wheel cylinder, half auto air bleeding cylinder can solve the problem easy way. Just one person press the button and step on the brake pedal, (the air bleeding work 1 time) and release the button and release the brake pedal, like this a few time repeat the air bleeding work is accomplished (Brake oil should be checked up and filled up in the master cylinder).

### BRIEF DESCRIPTION OF THE DRAWING

This Half Auto Air Bleeding Cylinder can solve the air bleeding problem easy way.

FIG. 1 is the simple drawing for understanding.

FIG. 2 At first, step on the brake pedal a few time, the air gather together near the bullet piston end. And then push the button, the magnetic is working and so the lock key open. Right this time step on the brake, the No. 3 rod goes up and the No. 2 rod goes down and so the bullet piston come down and the air with the brake oil bursting come out from the hole No. 5. It is a one time air bleeding accomplished. And so we can do a few time repeat, the air bleeding work can be done. After that we should check up the master cylinder and the master cylinder should be filled with proper amount of brake oil.

FIG. 2 The rod No. 1, 2, 3, 4 can be added if not enough strong.

FIG. 3 is different type of Half Auto Air Bleeding Cylinder, for the more small room than FIG. 2. At first step on the brake pedal a few time, the air with brake oil gather together No. 1 hole. And then push the button, the solenoid rod move left side and so can be opened the No. 1 hole, right this time step on the brake pedal the air with brake oil bursting come out to the right side air bleeding hole. This is a one time air bleeding accomplished. A few time repeat same way, the air bleeding work can be done. And master cylinder should be filled with proper amount of brake oil.

### DESCRIPTION OF THE PREFERRED EMBODIMENT

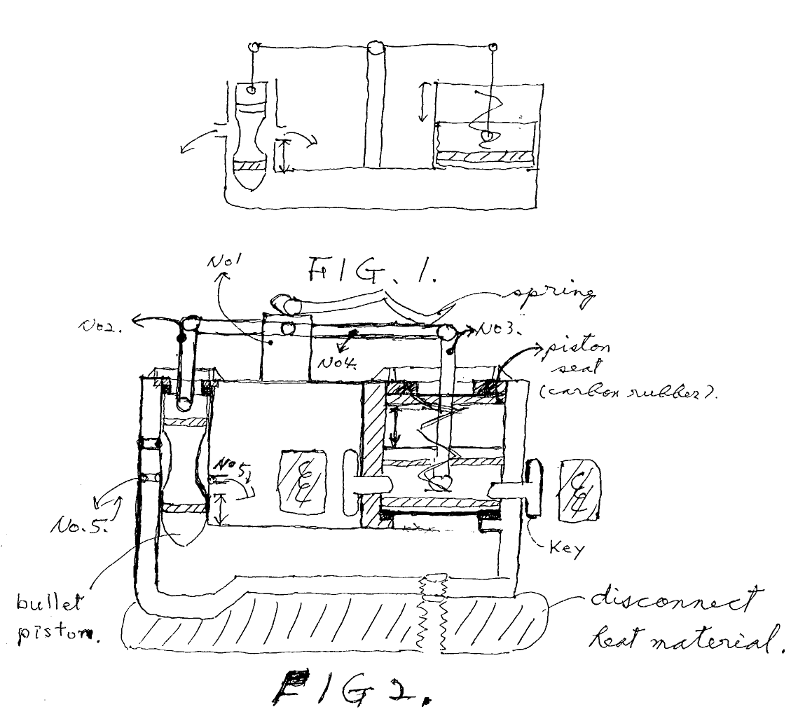

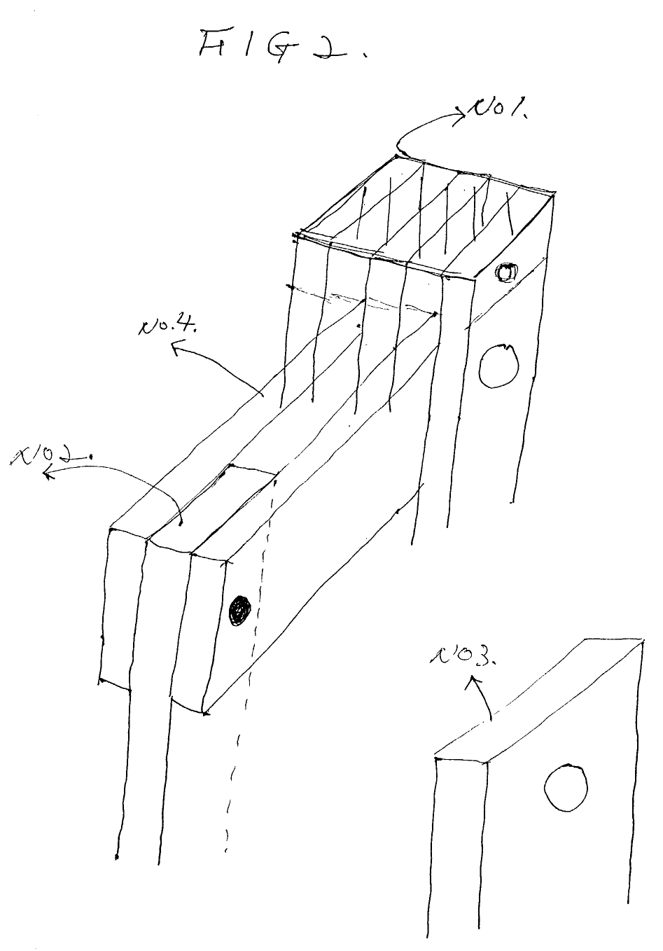

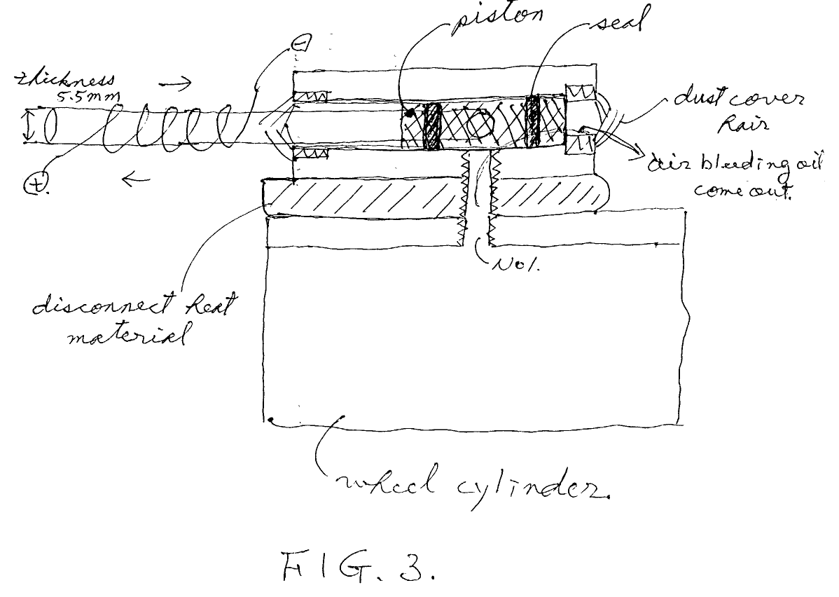

Referring to FIG. 3, the preferred embodiment of the present invention is very proper for the small room for the moving hand, because of the size is not too big to be set up. And need for perfect air bleeding in some case which we have to do roughly. And referring to FIG. 1 and FIG. 2. The half auto air bleeding cylinder can solve the vapor lock problem easy way and save time and labor.

What is claimed is:

1. Air Bleeding work is more easy way, if half auto air bleeding cylinder is used, so save efforts and time. And vapor lock problem can solve easy way (FIG. 1, FIG. 2).

2. For perfect air bleeding in some case which we have to do roughly, we need half auto air bleeding cylinder (FIG. 3).
